(19) United States
(12) Patent Application Publication
(10) Pub. No.: US 2026/0311469 A1
(43) Pub. Date: Oct. 8, 2026

(54) INSTANCE SEGMENTATION METHOD AND SYSTEM BASED ON SELF-ERROR ESTIMATION, AND METHOD AND SYSTEM FOR TRAINING MASK ESTIMATION MODEL THEREFOR

(71) Applicant: GWANGJU INSTITUTE OF SCIENCE AND TECHNOLOGY, Gwangju (KR)

(72) Inventors: Kyoobin LEE, Gwangju (KR); Seung Hyeok BACK, Gwangju (KR); Sang Beom LEE, Gwangju (KR); Kang Min KIM, Gwangju (KR); Sung Ho SHIN, Suwon-si (KR)

(73) Assignee: GWANGJU INSTITUTE OF SCIENCE AND TECHNOLOGY, Gwangju (KR)

(21) Appl. No.: 19/459,284

(22) Filed: Jan. 26, 2026

(30) Foreign Application Priority Data
Apr. 2, 2025 (KR) 10-2025-0042863

(51) Int. Cl. G06V 10/776; G06V 10/25; G06V 10/26; G06V 10/82

(52) U.S. Cl. CPC G06V 10/776; G06V 10/25; G06V 10/267; G06V 10/82

(57) ABSTRACT

An instance segmentation method including: receiving a target image; estimating an initial bounding box corresponding to a specific object from the target image and estimating, based on the initial bounding box, an initial instance mask for the specific object; predicting a self-error for the initial instance mask based on the initial bounding box; and estimating, from the target image, a bounding box corrected according to the self-error, in consideration of the self-error for the initial bounding box and estimating an instance mask, based on the corrected bounding box and the self-error.

### CROSS REFERENCE TO RELATED APPLICATION

The present application claims priority to Korean Patent Application No. 10-2025-0042863, filed Apr. 2, 2025, the entire contents of which are hereby incorporated by reference in its entirety.

### BACKGROUND

### Field

The present invention relates to an instance segmentation method and an instance segmentation system based on self-error estimation, and a method and system for training a mask estimation model therefor.

### Description of the Related Art

Instance segmentation, which is a technology in the field of computer vision that detects objects in an image and precisely distinguishes boundaries, may be applied to various fields ranging from autonomous driving to robot manipulation and agriculture, and active research is being conducted.

In this regard, recently, a two-stage paradigm introduced in Mask R-CNN has been known, and such a method is achieved in a manner of first detecting a bounding box for a predetermined object in an image and thereafter segmenting pixels corresponding to an instance mask for the object within the bounding box.

However, in conventional instance segmentation systems, bounding box estimation and instance mask estimation are performed as largely independent computational stages, and error information generated during mask estimation is not persistently reused within an internal processing pipeline of the model.

As a result, boundary inaccuracies are typically addressed by external post-processing operations or heuristic refinement steps, which increase computational overhead, require additional memory access, and often lead to unstable convergence behavior, particularly when executed on parallel processing hardware such as GPUs.

Accordingly, there exists a technical limitation in existing computer vision systems in that object boundary errors cannot be efficiently corrected within an internal inference loop of a single model architecture without redundant re-computation of feature maps.

### SUMMARY

The present invention relates to an instance segmentation method and an instance segmentation system based on self-error estimation, and a method and system for training a mask estimation model therefor that are capable of more accurately estimating an instance mask for an arbitrary object from an image.

In addition, the present invention relates to an instance segmentation method and an instance segmentation system based on self-error estimation, and a method and system for training a mask estimation model therefor that are capable of performing improvement for an instance mask estimated from an image more efficiently.

To achieve the aforementioned objects, there is provided an instance segmentation method, according to the present invention. The instance segmentation method may comprise: receiving a target image; estimating an initial bounding box corresponding to a specific object from the target image and estimating, based on the initial bounding box, an initial instance mask for the specific object; predicting a self-error for the initial instance mask based on the initial bounding box; and estimating, from the target image, a bounding box corrected according to the self-error, in consideration of the self-error for the initial bounding box and estimating an instance mask, based on the corrected bounding box and the self-error.

In addition, there is provided an instance segmentation system, according to the present invention. The instance segmentation system may comprise: a storage unit in which a target image is stored; and a control unit configured to estimate an instance mask from the target image, in which the control unit may: estimate an initial bounding box corresponding to a specific object from the target image; estimate, based on the initial bounding box, an initial instance mask for the specific object; predict a self-error for the initial instance mask based on the initial bounding box; estimate, from the target image, a bounding box corrected according to the self-error, in consideration of the self-error for the initial bounding box; and estimate an instance mask, based on the corrected bounding box and the self-error.

In addition, there is provided a program stored in a computer-readable recording medium, executed by one or more processes in an electronic device, according to the present invention. The program may comprise instructions to perform: receiving a target image; estimating an initial bounding box corresponding to a specific object from the target image and estimating, based on the initial bounding box, an initial instance mask for the specific object; predicting a self-error for the initial instance mask based on the initial bounding box; and estimating, from the target image, a bounding box corrected according to the self-error, in consideration of the self-error for the initial bounding box and estimating an instance mask, based on the corrected bounding box and the self-error.

In addition, there is provided a method for training a mask estimation model, according to the present invention. The method may comprise: receiving training images and ground-truth masks which are labeling data for the training images; inputting the training images to a mask estimation model to estimate a training initial instance mask for the training images; predicting a self-error for the training initial instance mask through the mask estimation model, and estimating, based on the self-error, a training instance mask corrected from the training initial instance mask; and comparing the training instance mask and the ground-truth masks, and training, based on a comparison result, the mask estimation model.

In addition, there is provided a system for training a mask estimation model, according to the present invention. The system may comprise: a storage unit in which training images and ground-truth masks which are labeling data for the training images are stored; and a control unit configured to train a mask estimation model by using the training images and the ground-truth masks, in which the control unit may: input the training images to a mask estimation model to estimate a training initial instance mask for the training images; predict a self-error for the training initial instance mask through the mask estimation model; estimate, based on the self-error, a training instance mask corrected from the training initial instance mask; compare the training instance mask and the ground-truth masks; and train, based on a comparison result, the mask estimation model.

In addition, there is provided a program stored in a computer-readable recording medium, executed by one or more processes in an electronic device, according to the present invention. The program may comprise instructions to perform: receiving training images and ground-truth masks which are labeling data for the training images; inputting the training images to a mask estimation model to estimate a training initial instance mask for the training images; predicting a self-error for the training initial instance mask through the mask estimation model, and estimating, based on the self-error, a training instance mask corrected from the training initial instance mask; and comparing the training instance mask and the ground-truth masks, and training, based on a comparison result, the mask estimation model.

According to various embodiments of the present invention, the instance segmentation method and the instance segmentation system based on self-error estimation, and the method and system for training a mask estimation model therefor, through a single model, may estimate an instance mask for a specific object from a target image, and, by correcting self-error, may more accurately estimate an instance mask for an arbitrary object from an image.

In addition, according to various embodiments of the present invention, the instance segmentation method and the instance segmentation system based on self-error estimation, and the method and system for training a mask estimation model therefor, by repeating a process of correcting self-error for a bounding box and an instance mask estimated from a target image, may perform improvement for an instance mask estimated from an image more efficiently.

A self-error-based iterative correction structure of the present invention, when compared with an existing Mask R-CNN structure, beyond simple ‘post-processing-based correction’, provides an ‘intrinsic error feedback mechanism’ that directly predicts and reflects an error of an object boundary inside a model.

A self-error-based iterative correction structure of the present invention, compared with conventional representative 2-stage instance segmentation models (for example, Mask R-CNN series models), goes beyond simple post-processing-based correction and provides an intrinsic error feedback mechanism that directly predicts and reflects errors of object boundaries inside a model.

Such a structure is not dependent on a specific model and may be equally applied across various 2-stage instance segmentation architectures including a bounding box head and a mask head.

Accordingly, even in a situation when an initial bounding box is inaccurate or overlap between objects exists, segmentation results that gradually converge to an actual object shape may be obtained through iterative correction, and, even for objects having complex boundaries or fine structures (hair, tree branches, wires, etc.), segmentation accuracy higher compared with existing methods may be achieved.

Such a technical effect is distinguished from an effect obtainable by a simple increase in network capacity, and may be understood as being due to a structural feature in which a model ‘self-diagnoses and corrects self-error’.

The present invention is not directed merely to analyzing image data or applying mathematical operations, but to improving an internal operation of an instance segmentation system by restructuring how feature maps, error information, and bounding box parameters are generated, stored, and reused within a single model.

In particular, the invention introduces a self-error tensor that is persistently maintained in memory and directly integrated into subsequent bounding box and mask estimation processes, thereby modifying how the computer executes iterative segmentation inference and reducing redundant computational cycles.

### BRIEF DESCRIPTION OF THE DRAWINGS

FIG. 1 illustrates a structure of a mask estimation model according to the present invention.

FIG. 2 illustrates an instance segmentation system according to the present invention.

FIG. 3 is a flowchart illustrating an instance segmentation method according to the present invention.

FIG. 4 illustrates a system for training a mask estimation model according to the present invention.

FIG. 5 is a flowchart illustrating a method for training a mask estimation model according to the present invention.

### DETAILED DESCRIPTION

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be understood that the accompanying drawings are provided only to easily understand the embodiments disclosed in the present specification, and the technical teachings disclosed in the present specification are not limited by the accompanying drawings, and includes all alterations, equivalents, and alternatives that are included in the teachings and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. However, when one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including”, “having”, and the like are intended to designate the existence of characteristics (or features), numbers, steps, operations, constituent elements, and components described in the specification or a combination thereof, and do not exclude a possibility of the existence or addition of one or more other characteristics (or features), numbers, steps, operations, constituent elements, and components, or a combination thereof in advance.

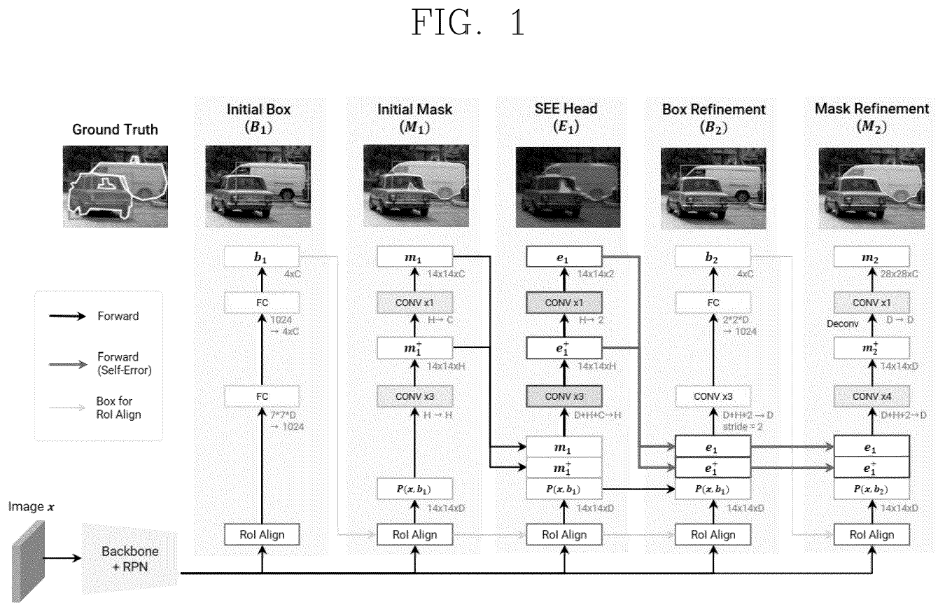

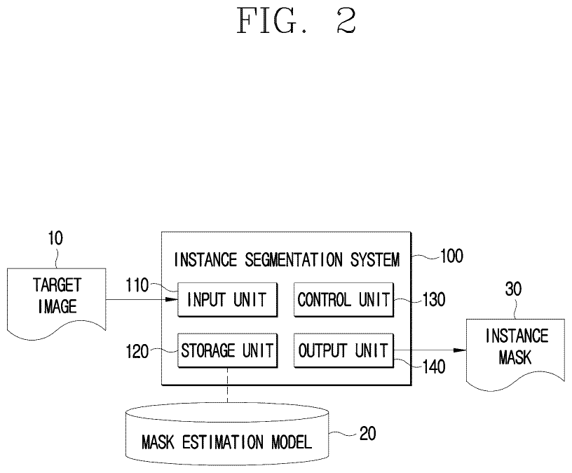

FIG. 1 illustrates a structure of a mask estimation model according to the present invention. FIG. 2 illustrates an instance segmentation system according to the present invention.

With reference to FIG. 1, an instance segmentation system 100 according to the present invention, by using a mask estimation model, may estimate an initial bounding box (for example, B1, Initial Box) and an initial instance mask (for example, M1, Initial Mask) for a specific object from a target image, and, according to the initial bounding box and the initial instance mask, self-error (for example, E1, S is predicted, and, by correcting each of the initial bounding box and the initial instance mask based on the predicted self-error, may estimate an instance mask.

The self-error is not an abstract evaluation result, but is implemented as a pixel-wise error tensor having a fixed spatial resolution corresponding to an output of the instance mask head. The self-error tensor is stored in memory as an intermediate feature map and is directly reused as an input channel for subsequent bounding box correction and instance mask estimation operations, thereby forming a persistent internal feedback path within the model.

A mask estimation model, as a single model, may estimate a bounding box and an instance mask for a specific object from a target image, and, by predicting self-error for each of the bounding box and the instance mask, may be implemented and trained to correct each of the previously estimated bounding box and the previously estimated instance mask.

Such a mask estimation model may include a region proposal network (RPN), a bounding box head, RoI Align operation, an instance mask head, and a self-error prediction head, and respective components may be implemented to be repeated according to a number of times of correcting, through the mask estimation model, each of the bounding box and the instance mask, or to be performed stepwise. In one embodiment, the self-error prediction head uses, as an input, a first tensor (region of interest feature) of (H×W×C₁) and an initial instance mask feature of (H×W×C₂) by combining in a channel direction, and self-error to be predicted may be generated as a pixel-based probability map of (H×W). Also, a correction loop is repeatedly performed up to a maximum of T times from t=0 to t=T, and T may be set, for example, between 1 and 5. A repetition termination condition may be automatically terminated when (a) a rate of change of self-error is equal to or less than a threshold, or (b) an amount of change of a corrected bounding box is equal to or less than a predefined value. Feature combination may be implemented as one of channel-wise concatenation or element-wise addition, and the present invention may encompass any combination methods including these. Further, in one embodiment, the self-error prediction head uses, as an input, a tensor obtained by combining, in a channel direction, a feature map calculated through RoI Align and an initial instance mask, and may be configured to output a self-error map of size H×W representing a pixel-level error probability distribution. In this case, a combination operation may be implemented as one of channel-direction concatenation or element-wise addition. Also, a correction loop may be repeatedly performed from t=0 to t=T, and T may be set in a range of 1 to 5. Regarding whether to terminate repetitions, in case (i) a rate of change of a self-error value is less than a set threshold, or (ii) an amount of positional change of a corrected bounding box is less than a predefined threshold, then early termination may be done. Further, a corrected bounding box may be calculated, with respect to an initial bounding box bt, by using movement/scaling parameters (Δx, Δy, Δw, Δh) derived from a self-error prediction result, in a manner of bt+1=(x+Δx, y+Δy, w·exp(Δw), h·exp(Δh)). Through this, a model of the present invention may structurally re-estimate an object boundary according to a clear mathematical transformation procedure rather than functional correction.

In particular, a self-error map is a value that a model directly predicts as to whether pixel-level deviation occurs by comparing a GT (ground truth) of an initial instance mask, has the same spatial resolution as a mask head output, and may be configured as a 2-channel (True/False) probability vector indicating, for each pixel, ‘whether accurately segmented’, ‘whether background but misclassified as object’, and ‘whether object but misclassified as background’.

Generation of such a self-error map may be performed through a single convolution-based prediction head, and, by applying Softmax, 2-channel probabilities indicating, for each pixel, whether the pixel is correctly segmented (True) or whether an error occurs (False) may be output.

A model is trained to determine a bounding box correction direction by using regions with high error probability in a self-error map as an emphasis signal.

For example, in a case in which error probability is high around a specific boundary, the corresponding region is determined as a region requiring more precise correction, and the model, by adjusting a position or a size of a bounding box in a direction in which errors are concentrated, may estimate a more accurate object boundary.

Such a manner, rather than classifying error types in a fine-grained manner, operates in a form of gradually reducing regions with high errors during an iterative correction process on the basis of a simple and stable structure that directly predicts whether an error occurs itself.

Such a manner allows estimation of a true position and a size of an object in a more intuitive manner than a conventional simple regression-based bounding box regression, thereby enabling achievement of high accuracy, in particular, even in objects having irregular boundaries or in complex background conditions.

In this case, RPN may be implemented to propose a bounding box for a specific object from a target image, a bounding box head may be implemented as at least one of a plurality of fully connected (FC) layers and a plurality of convolution layers so as to estimate a bounding box for a target object based on a bounding box proposed by RPN, and a RoI Align operation may be implemented to specify a region of interest according to a bounding box from a target image. Also, an instance mask head may be implemented as a plurality of convolution layers so as to estimate an instance mask for a target object appearing from a target image based on a bounding box, and a self-error prediction head may be implemented as a plurality of convolution layers so as to predict self-error for a bounding box and an instance mask.

In one embodiment, a mask estimation model may be implemented based on a Mask R-CNN structure, however, this is merely one example, and a self-error-based correction module (SEED) of the present invention is not limited to Mask R-CNN and may be a universal plug-in module designed to be combinable with various 2-stage instance segmentation models including a bounding box head and a mask head.

Meanwhile, a target image is one including an arbitrary object, may be an image photographed through a photographing device such as a camera, or may be a rendered image through a rendering device or the like.

In addition, a bounding box may be one that specifies a region in which a specific object exists in a target image in a box shape (or, a rectangle), and an instance mask may be one that specifies pixels in which a specific object exists in a target image.

Meanwhile, with reference to FIG. 2, the instance segmentation system 100 according to the present invention may include an input unit 110, a storage unit 120, a control unit 130, and an output unit 140. Such an input unit 110, a storage unit 120, a control unit 130, and an output unit 140 may be connected to each other through a system bus, a network, or other connection mechanisms.

The input unit 110 may have information necessary for operation of the instance segmentation system 100 according to the present invention be input. To this end, the input unit 110 may be connected to a separate input device, a server, or an external storage device, and the like, by a wireless or wired network. For example, the input unit 110 may have predetermined information be input based on a touch screen, a computer mouse, a keyboard, a keypad, a touch pad, a trackball, a joystick, a voice recognition module, or other similar devices, and the like.

Accordingly, the input unit 110 may receive a target image 10 from a separate input device, a server, or an external storage device, and the like.

Also, the storage unit 120 may have commands and information necessary for operation of the instance segmentation system 100 be stored. Such a storage unit 120, as data storage, may include one or more non-transitory computer-readable storage media that may be read and/or accessed by the control unit 130 (for example, at least one of one or more processors).

One or more non-transitory computer-readable storage media may include volatile and/or non-volatile storage constituent elements such as optical, magnetic, organic, or other memory or disk storage devices. In some examples, the storage unit 120 may be implemented using a single physical device (for example, one optical, magnetic, organic, or other memory or disk storage device), whereas in other examples, the storage unit 120 may be implemented using two or more physical devices.

In addition, the storage unit 120 may include computer-readable instructions and additional data. The storage unit 120 may include storage necessary to perform at least a part of methods, scenarios, and techniques described in the present specification and/or at least a part of functions of devices and networks.

Accordingly, the storage unit 120 may have a target image 10 be stored. Also, the storage unit 120 may have a pre-trained mask estimation model 20 be stored, and initial bounding box, initial instance mask, self-error, a corrected bounding box, and a corrected instance mask 30, and the like, generated from the mask estimation model 20 may be stored.

The control unit 130 may control overall operation of the instance segmentation system 100. Such a control unit 130, as one or more processors, may include one or more general-purpose processors and/or one or more special-purpose processors (for example, a digital signal processor, a tensor processing unit (TPU), a graphics processing unit (GPU), a neural processing unit (NPU), an application-specific integrated circuit, an application-specific semiconductor (ASIC), etc.). The instance segmentation system of the present invention is preferably executed on a processor capable of parallel processing including a GPU, a TPU, or an NPU, and such hardware may process, in real time, large-scale tensor operations required in image feature extraction, mask generation, error map calculation, and iterative correction processes.

Also, the storage unit may cache intermediate feature maps, coordinate information, and loss function values required in tensor operations, and may process large-capacity images without delay by connecting DRAM and a high-speed interface. Such a configuration includes a specific computer architecture beyond a simple software algorithm, and, therefore, a technical configuration of the present invention becomes one that includes a clear technical means rather than an abstract idea under United States patent law.

The control unit 130 may be configured to execute computer-readable instructions included in the storage unit 120 and/or other commands described in the present specification.

Accordingly, the control unit 130, by using the mask estimation model 20, may estimate an initial bounding box and an initial instance mask for a specific object from a target image 10, may predict self-error according to an initial bounding box and an initial instance mask, and, by correcting each of an initial bounding box and an initial instance mask based on predicted self-error, may estimate an instance mask 30.

Specifically, the control unit 130 may receive a target image 10, may estimate an initial bounding box corresponding to a specific object from the target image 10, and, based on an estimated initial bounding box, may estimate an initial instance mask for a specific object.

To this end, the control unit 130 may, by using a pre-trained mask estimation model 20, estimate a region corresponding to a specific object from the target image 10 and may generate an initial bounding box. In addition, the control unit 130 may, through the pre-trained mask estimation model 20, estimate pixels corresponding to a specific object from an initial bounding box and may generate an initial instance mask.

Further, the control unit 130 may, based on an initial bounding box, predict self-error for an initial instance mask. To this end, the control unit 130 may, through the pre-trained mask estimation model 20, in the target image 10, combine a region of interest according to an initial bounding box and an initial instance mask, and may predict self-error from combined data.

Also, the control unit 130 may, in consideration of self-error for an initial bounding box, estimate a bounding box corrected according to self-error from the target image 10, and, based on a corrected bounding box and self-error, may estimate an instance mask 30.

That is, the control unit 130 may, through the pre-trained mask estimation model 20, by combining self-error predicted before an initial bounding box, estimate a bounding box in which an initial bounding box is corrected according to self-error. In the present invention, a bounding box correction step is performed based on a gradient-like correction value derived from a self-error map, rather than a simple coordinate modification. Specifically, a model integrates probability density of an error map in an initial box boundary region to calculate Δx, Δy, Δw, and Δh, which mean a movement amount of a box center and an amount of size change, respectively.

For example, when an ‘object but mis-separated as background (under-segmentation)’ error highly appears around a left boundary of a box, Δx may instruct movement in a negative direction, and width is adjusted in a direction of increase. Such correction is performed by the same procedure regardless of an image direction, a shape of an object, and a complexity of a region, so a model has a consistent and reproducible correction manner.

Correction may be performed one time or multiple times repeatedly, and each repetition uses a corrected box calculated in a previous step as an input to gradually generate a more accurate box position. This has a characteristic that an error reduction effect is accumulated as repetition proceeds, so fine-grained correction for an object boundary becomes possible.

Further, the control unit 130 may, through the pre-trained mask estimation model 20, combine a corrected bounding box according to self-error and self-error, and may estimate an instance mask 30 corrected according to self-error from combined data.

The output unit 140 may have information generated by operation of the instance segmentation system 100 according to the present invention be output. To this end, the output unit 140 may be connected to a separate visual output device, a server, or an external storage device, and the like, by a wireless or wired network.

For example, the output unit 140 may be configured to provide an output to a user display device such as one or more cathode ray tubes (CRT), a liquid crystal display, a light emitting diode (LED), a display using digital light processing (DLP) technology, or a printer. In addition, the output unit 140 may be configured to generate an audible output by using devices such as a speaker, a speaker jack, an audio output port, an audio output device, an earphone, and/or other similar devices, and may be additionally configured with one or more haptic devices capable of generating a haptic output such as vibration and/or other outputs detectable by touch and/or physical contact.

Accordingly, the output unit 140 may output, through a separate output device, a server, or an external storage device, and the like, so that a user may visually check, a target image 10, an initial bounding box, an initial instance mask, self-error, a corrected bounding box, and a corrected instance mask 30, and the like, and, according to embodiments, may also deliver the target image 10, an initial bounding box, an initial instance mask, self-error, a corrected bounding box, and a corrected instance mask 30, and the like, to another device.

Meanwhile, the instance segmentation system 100 may be a computing device including one or more sensors and/or a power system. Here, one or more sensors may be configured to measure conditions in the computing device and/or conditions of a computing-device environment and to provide data regarding these conditions. A power system may include one or more batteries and/or one or more external power interfaces for supplying power to the computing device.

Based on the configuration of the instance segmentation system 100 examined above, hereinafter, an instance segmentation method will be described in more detail.

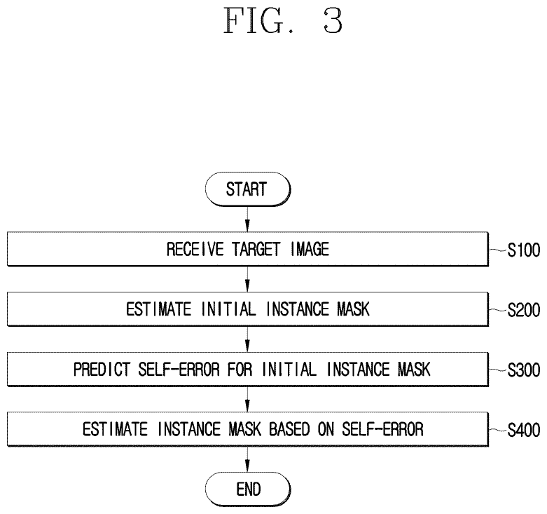

FIG. 3 is a flowchart illustrating an instance segmentation method according to the present invention.

With reference to FIG. 3, the instance segmentation system 100 according to the present invention receives a target image (S100), estimates an initial bounding box corresponding to a specific object from the target image, and, based on the estimated initial bounding box, may estimate an initial instance mask for the specific object (S200).

Specifically, the instance segmentation system 100 may, by using a pre-trained mask estimation model, estimate a region corresponding to a specific object from a target image and may generate an initial bounding box.

For example, the instance segmentation system 100 may, through fully connected layers of the mask estimation model, estimate a region corresponding to a specific object from the target image as an initial bounding box. To this end, the mask estimation model may include a plurality of fully connected layers.

Accordingly, the instance segmentation system 100 may, through a plurality of fully connected layers, specify a region corresponding to a specific object from the target image, and may generate an initial bounding box representing the specified region.

In one embodiment, the instance segmentation system 100 may generate an initial bounding box from the target image according to Equation 1 below.

$${b}_{0} = RPN ( x ) \qquad [ Equation 1 ]$$

$${b}_{1} = {B}_{1} ( P ( x , {b}_{0} ) )$$

Here, RPN may be an RPN included in the mask estimation model, b₀ denotes a bounding box proposed by RPN, and x may denote the target image. Also, B₁ may be an initial bounding box head included in the mask estimation model, P may be a RoI Align operation, and b₁ may denote an initial instance mask estimated by the mask estimation model.

That is, the instance segmentation system 100 estimates a bounding box proposed for a specific object from the target image through Region Proposal Network, extracts RoI features for the previously proposed bounding box through RoI Align operation, and, through an initial bounding box head, processes the previously extracted RoI features to generate an initial bounding box for the target image.

Further, the instance segmentation system 100 may, through a pre-trained mask estimation model, estimate pixels corresponding to a specific object from an initial bounding box and may generate an initial instance mask.

For example, the instance segmentation system 100 may, through convolution layers of the mask estimation model, estimate an initial instance mask for a specific object appearing in a region corresponding to the initial bounding box from the target image. To this end, the mask estimation model may include a plurality of convolution layers.

That is, the instance segmentation system 100 generates an intermediate mask as a feature corresponding to a region corresponding to the initial bounding box from the target image through a plurality of convolution layers, and, based on the generated intermediate mask, may estimate a region corresponding to an initial instance mask.

In one embodiment, the instance segmentation system 100 may generate an initial instance mask corresponding to the target image and the initial bounding box according to Equation 2 below.

$${m}_{1} = {M}_{1} ( P ( x , {b}_{1} ) ) \qquad [ Equation 2 ]$$

Here, m₁ denotes an initial instance mask, and M₁ may be an initial instance mask head included in a mask estimation model.

That is, the instance segmentation system 100 may, through an initial instance mask head, generate an initial instance mask corresponding to a specific object within an initial bounding box.

The instance segmentation system 100 according to the present invention may predict self-error for an initial instance mask based on an initial bounding box (S300).

Specifically, the instance segmentation system 100 may, through a pre-trained mask estimation model, combine a region of interest according to an initial bounding box and an initial instance mask in a target image, and may predict self-error from combined data.

For example, the instance segmentation system 100 may combine a region of interest according to an initial bounding box and an initial instance mask, and may estimate self-error for an initial instance mask at an initial bounding box from previously combined data through convolution layers of a mask estimation model.

To this end, an instance segmentation system 100 generates an intermediate self-error as a feature corresponding to combined data of a region of interest according to an initial bounding box and an initial instance mask through a plurality of convolution layers, and, based on the generated intermediate self-error, may predict self-error corresponding to an initial bounding box and an initial instance mask.

In one embodiment, the instance segmentation system 100 may generate self-error corresponding to an initial bounding box and an initial instance mask according to Equation 3 below.

$${e}_{t} = {E}_{t} ( P ( x , {b}_{t} ) , {m}_{t}^{+} , {m}_{t} ) \qquad [ Equation 3 ]$$

Here, et denotes self-error, Eₜ is a self-error prediction head, mₜ⁺ denotes an intermediate mask, and mt may denote an initial instance mask.

In this case, the instance segmentation system 100 may predict self-error on a pixel basis (i.e., pixel unit, pixel level, etc.) with respect to an initial bounding box and an initial instance mask.

The instance segmentation system 100 according to the present invention may, in consideration of self-error for an initial bounding box, estimate a bounding box corrected according to self-error from a target image, and, based on a corrected bounding box and self-error, may estimate an instance mask (S400).

The corrected bounding box may be calculated, for an initial bounding box bₜ, by calculating movement/scaling parameters Δx, Δy, Δw, and Δh derived from eₜ, in a manner of bₜ₊₁=(x+Δx, y+Δy, w·exp(Δw), h·exp(Δh)). The corresponding parameters are calculated by inputting a feature vector obtained through convolution layers into fully connected layers, and, therefore, may be implemented as a clear mathematical transformation procedure rather than a simple functional result.

Specifically, the instance segmentation system 100 may, through a pre-trained mask estimation model, by combining self-error predicted before an initial bounding box, estimate a corrected bounding box in which an initial bounding box is corrected according to self-error.

For example, an instance segmentation system 100 may combine self-error predicted before an initial bounding box, and may estimate a corrected bounding box corresponding to previously combined data through convolution layers and fully connected layers of a mask estimation model.

That is, the instance segmentation system 100 extracts a feature vector for previously combined data through convolution layers, and may estimate a corrected bounding box corresponding to the previously extracted feature vector through fully connected layers.

In one embodiment, an instance segmentation system 100 may generate a corrected bounding box from an initial bounding box and self-error according to Equation 4 below.

$${b}_{t + 1} = {B}_{t} ( P ( x , {b}_{t} ) , {e}_{t}^{+} , {e}_{t} ) \qquad [ Equation 4 ]$$

Here, bₜ₊₁ denotes a corrected bounding box, and eₜ⁺ denotes an intermediate self-error, and bₜ may denote an initial bounding box (or a previously estimated bounding box according to iterative estimation). Also, Bₜ may be a bounding box head included in a mask estimation model, and t may denote a number of repeated corrections.

Further, the instance segmentation system 100 may, through a pre-trained mask estimation model, combine a corrected bounding box according to self-error and self-error, and may estimate a corrected instance mask according to self-error from combined data.

For example, the instance segmentation system 100 may combine a corrected bounding box and self-error, and may estimate an instance mask corrected to correspond to a specific object from previously combined data through convolution layers of a mask estimation model.

That is, the instance segmentation system 100, through a plurality of convolution layers, generates an intermediate mask as a feature that corresponds to the previously combined data from a target image, and, based on the generated intermediate mask, may estimate an instance mask corresponding to a specific object.

The correction parameters (Δx, Δy, Δw, Δh) are not abstract mathematical values, but are derived from convolutional feature aggregation over regions exhibiting high error density in the self-error tensor.

Accordingly, the bounding box update represents a concrete transformation applied to stored bounding box data structures in memory, executed through a predefined computational graph on a parallel processing unit.

In one embodiment, the instance segmentation system 100 may generate an instance mask corresponding to a corrected bounding box and self-error according to Equation 5 below.

$${m}_{t + 1} = {M}_{t} ( P ( x , {b}_{t + 1} ) , {e}_{t}^{+} , {e}_{t} ) \qquad [ Equation 5 ]$$

Here, mₜ₊₁ denotes a corrected instance mask, and Mₜ may be an initial instance mask head included in a mask estimation model, and t may denote a number of repeated corrections.

Accordingly, the instance segmentation system 100 may, based on self-error predicted for an initial bounding box and an initial instance mask, correct the initial bounding box and the initial instance mask to estimate a bounding box and an instance mask.

An instance mask estimated based on a corrected bounding box reflects more refined object boundary information than an existing initial mask. An improved mask uses a self-error map together as an input, and, in this case, an error map plays a role of emphasizing ‘a region that should be guided to accurate segmentation’ from an intermediate mask.

Mask correction is usually performed through a decoder structure combining upsampling and convolution, and, if necessary, a skip connection may be added to restore high-resolution boundary information. Also, in the present embodiment, since an error map is used as an additional channel to train a network to compensate for inaccuracy at boundaries, as a result, a contour of an object including fine structures may be reproduced more smoothly and closer to an actual shape.

In addition, the instance segmentation system 100 may repeat a process of correcting a previously estimated bounding box and a previously estimated instance mask according to a predetermined number of repetitions of correction, and, in this case, an instance segmentation system 100, based on self-error predicted for a previous bounding box and a previous instance mask that are previously estimated, may correct the previous bounding box and the previous instance mask to estimate a new bounding box and an instance mask. Meanwhile, the instance segmentation system 100 according to the present invention may estimate an instance mask for a specific object from a target image by using a mask estimation model learned by a system 200 for training a mask estimation model. To this end, the system 200 for training a mask estimation model according to the present invention may train a mask estimation model by using training images and ground-truth masks. In one embodiment, training images are resized to a fixed size (for example, 1024×1024), and ground-truth masks are normalized to the same resolution to be used as model inputs. A training batch may be configured by mixing images in which multiple objects exist and single-object images, which makes a self-error prediction head generalize to various object boundary conditions. Also, model inputs may be configured as a triple input structure of (image tensor, bounding box tensor, mask tensor), and such a structure may be optimized to enable GPU- or TPU-based parallel operations.

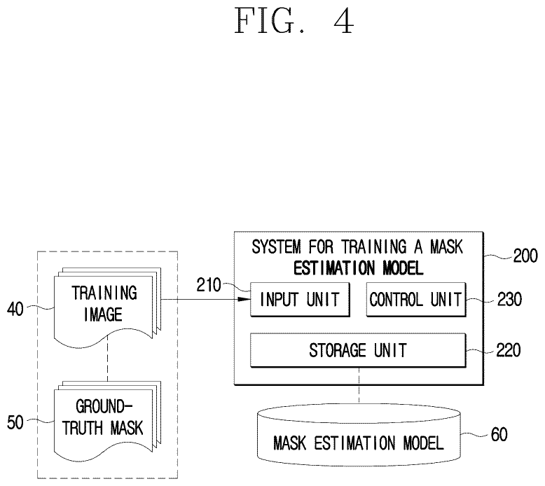

Hereinafter, the system 200 for training a mask estimation model according to the present invention will be described in more detail with reference to FIG. 4. FIG. 4 illustrates a system for training a mask estimation model according to the present invention.

With reference to FIG. 4, the system 200 for training a mask estimation model according to the present invention, by using training images 40 and ground-truth masks 50, when a predetermined target image is input, so as to estimate an instance image for a specific object appearing in the target image, may train a mask estimation model 60.

To this end, the system 200 for training a mask estimation model according to the present invention may include an input unit 210, a storage unit 220, and a control unit 230. Such an input unit 210, a storage unit 220, and a control unit 230 may be connected to each other through a system bus, a network, or other connection mechanisms. In one embodiment, the control unit is implemented by a tensor operation accelerator based on a GPU or an NPU, and has a structure capable of loading and computing adjacent pixel features in parallel on memory. Such a configuration, as an image processing method utilizing a specific hardware architecture rather than a simple mathematical operation, includes a concrete technical means in the field of computer technology.

The input unit 210 may have information necessary for operation of the system 200 for training a mask estimation model according to the present invention be input. To this end, the input unit 210 may be connected to a separate input device, a server, or an external storage device, and the like, by a wireless or wired network. For example, the input unit 210 may have predetermined information be input based on a touch screen, a computer mouse, a keyboard, a keypad, a touch pad, a trackball, a joystick, a voice recognition module, or other similar devices, and the like.

Accordingly, the input unit 210 may receive training images 40 and ground-truth masks 50 from a separate input device, a server, or an external storage device, and the like. Also, the input unit 210, according to embodiments, may further receive ground-truth bounding boxes together with training images 40 and ground-truth masks 50.

Additionally, the storage unit 220 may have commands and information necessary for operation of a system 200 for training a mask estimation model be stored. Such a storage unit 220, as data storage, may include one or more non-transitory computer-readable storage media that may be read and/or accessed by the control unit 230 (for example, at least one of one or more processors).

One or more non-transitory computer-readable storage media may include volatile and/or non-volatile storage constituent elements such as optical, magnetic, organic, or other memory or disk storage devices. In some examples, the storage unit 220 may be implemented using a single physical device (for example, one optical, magnetic, organic, or other memory or disk storage device), whereas in other examples, the storage unit 220 may be implemented using two or more physical devices.

In addition, the storage unit 220 may include computer-readable instructions (directives) and additional data. The storage unit 220 may include storage necessary to perform at least a part of methods, scenarios, and techniques described in the present specification and/or at least a part of functions of devices and networks.

Accordingly, the storage unit 220 may have training images 40, ground-truth masks 50, and ground-truth bounding boxes be stored. Also, the storage unit 220 may have a mask estimation model 60 be stored, and various data generated through a mask estimation model 60 and a loss function calculated with respect to a mask estimation model 60, and the like may be stored.

The control unit 230 may control overall operation of a system 200 for training a mask estimation model. Such a control unit 230, as one or more processors, may include one or more general-purpose processors and/or one or more special-purpose processors (for example, a digital signal processor, a tensor processing unit (TPU), a graphics processing unit (GPU), a neural processing unit (NPU), an application-specific integrated circuit, an application-specific semiconductor (ASIC), etc.). The control unit 230 may be configured to execute computer-readable instructions (directives) included in the storage unit 220 and/or other commands described in the present specification.

Accordingly, a control unit 230, by using training images 40 and ground-truth masks 50, when a predetermined target image is input, so as to estimate an instance image for a specific object appearing in the target image, may train a mask estimation model 60.

Specifically, the control unit 230 may receive training images 40 and ground-truth masks 50 which are labeling data for training images 40. That is, the control unit 230, together with training images 40, may receive ground-truth masks 50 representing an instance mask for a specific object appearing in training images 40. In this case, the system 200 for training a mask estimation model, together with ground-truth masks 50, may further receive ground-truth bounding boxes representing a region of interest in which a specific object exists in training images 40.

Accordingly, the control unit 230 inputs training images 40 to the mask estimation model 60 to estimate a training initial instance mask for training images 40, and, through the mask estimation model 60, may predict self-error for the training initial instance mask, and, based on self-error, may estimate a training instance mask corrected from the training initial instance mask. In one embodiment, training images are resized to a fixed size (for example, 1024×1024), and ground-truth masks are normalized to the same resolution to be used as model inputs. A training batch may be configured by mixing images in which multiple objects exist and single-object images, which makes a self-error prediction head generalize to various object boundary conditions. Also, model inputs may be configured as a triple input structure of (image tensor, bounding box tensor, mask tensor), and such a structure may be optimized to enable GPU- or TPU-based parallel operations.

To this end, the control unit 230, by using the mask estimation model 60, may estimate a region corresponding to a specific object from training images 40 and may generate a training initial bounding box, and, by estimating pixels corresponding to a specific object from a training initial bounding box, may generate a training initial instance mask, and, in training images 40, may combine a region of interest according to a training initial bounding box and a training initial instance mask, and may predict a training self-error from combined data.

Also, the control unit 230, through the mask estimation model 60, by combining a training self-error predicted before a training initial bounding box, may estimate a training corrected bounding box in which a training initial bounding box is corrected according to a training self-error, and, by combining a training corrected bounding box corrected according to a training self-error and a training self-error, and from the combined data, may estimate a training instance mask corrected according to a training self-error.

Further, the control unit 230 may compare a training instance mask and ground-truth masks 50, and, based on a comparison result, may train the mask estimation model 60.

That is, the control unit 230 may calculate a loss function for a mask estimation model 60 by comparing a training instance mask and ground-truth masks 50, and, by using the calculated loss function, may train the mask estimation model 60.

Meanwhile, the system 200 for training a mask estimation model may be a computing device including one or more sensors and/or a power system. Here, one or more sensors may be configured to measure conditions in the computing device and/or conditions of a computing-device environment and to provide data regarding these conditions. A power system may include one or more batteries and/or one or more external power interfaces for supplying power to the computing device.

Based on a configuration of the system 200 for training a mask estimation model described above, a method for training a mask estimation model will be described below in more detail.

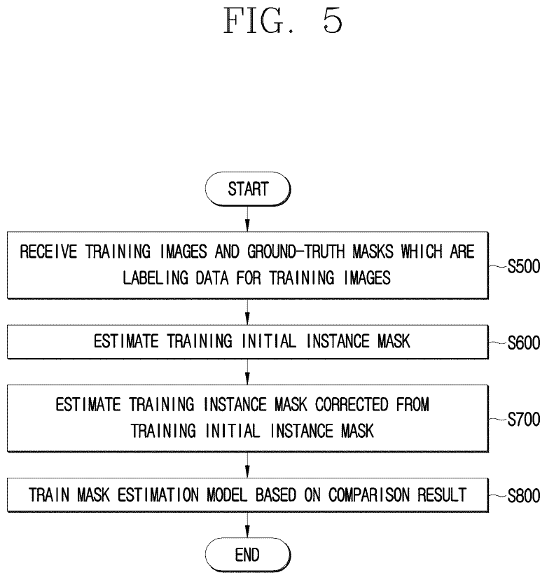

FIG. 5 is a flowchart illustrating a method for training a mask estimation model according to the present invention.

With reference to FIG. 5, the system 200 for training a mask estimation model according to the present invention may receive training images and ground-truth masks which are labeling data for training images (S500).

Specifically, the system 200 for training a mask estimation model may, together with training images, receive ground-truth masks representing an instance mask for a specific object appearing in training images. In this case, the system 200 for training a mask estimation model, together with ground-truth masks, may further receive ground-truth bounding boxes representing a region of interest in which a specific object exists in training images.

Further, the system 200 for training a mask estimation model according to the present invention, by inputting training images to a mask estimation model, may estimate a training initial instance mask for training images (S600), may predict self-error for the training initial instance mask through the mask estimation model, and, based on self-error, may estimate a training instance mask corrected from the training initial instance mask (S700).

Specifically, the system 200 for training a mask estimation model, by using a mask estimation model, may estimate a region corresponding to a specific object from training images to generate a training initial bounding box, may estimate pixels corresponding to a specific object from the training initial bounding box to generate a training initial instance mask, and, in training images, may combine a region of interest according to the training initial bounding box and the training initial instance mask, and may predict a training self-error from combined data.

In addition, the system 200 for training a mask estimation model, through the mask estimation model, by combining a training self-error predicted before a training initial bounding box, may estimate a training corrected bounding box in which the training initial bounding box is corrected according to the training self-error, and, by combining a training corrected bounding box corrected according to the training self-error and the training self-error, and from combined data, may estimate a training instance mask corrected according to the training self-error.

In a training process, a model may be trained by using an image set including multiple object types and various object size distributions. Training images are input after normalization and resizing in advance, and ground-truth bounding boxes and ground-truth masks are converted to the same resolution and aligned with model input tensors.

A training batch is configured by mixing multi-object images, single-object images, partially occluded images, and the like, and this allows a self-error prediction head to learn various error occurrence patterns. It is effective to train as a model sensitive to boundary errors by including many objects having complex boundaries (hair, plants, wire mesh, etc.) in particular.

Also, in training, an adaptive weighting strategy of adjusting error map training weights according to labeling quality of objects may be used. For example, in initial epochs, a loss weight of an error map is increased so that a model quickly learns error patterns, and, in later epochs, a ratio of a mask loss is increased to reinforce precise segmentation capability.

Further, the system 200 for training a mask estimation model according to the present invention may compare a training instance mask and ground-truth masks, and, based on a comparison result, may train a mask estimation model (S800).

Specifically, the system 200 for training a mask estimation model may calculate a loss function for a mask estimation model by comparing a training instance mask and ground-truth masks, and, by using the calculated loss function, may train a mask estimation model.

For example, the system 200 for training a mask estimation model may respectively calculate a self-error loss, a bounding box loss, and an instance mask loss. To this end, a system 200 for training a mask estimation model may calculate ground-truth self-error by comparing a training instance mask and ground-truth masks.

In one embodiment, the system 200 for training a mask estimation model may calculate ground-truth self-error according to Equation 6 below.

$${e}_{t} \approx \overline{e} = [ 1 ( {m}_{t} = \overline{m} ) , 1 ( {m}_{t} \neq \overline{m} ) ] ∈ {R}^{w \times h \times 2} \qquad [ Equation 6 ]$$

Here, ē denotes ground-truth self-error, m̅ denotes a ground-truth mask, w denotes a width of a target image (or an instance mask), and h may denote a height of a target image (or an instance mask). Also, 1 is an indicator function according to a pixel unit, and [,] may denote channel-wise concatenation.

That is, the system 200 for training a mask estimation model may, on a pixel basis, compare a training instance mask and a ground-truth mask, and, according to a comparison result, may specify a plurality of pixels having different values between a training instance mask and a ground-truth mask and may calculate ground-truth self-error.

In a training stage, ground-truth self-error may be generated as a 2-channel (binary) error map by comparing a ground-truth mask and a training instance mask on a pixel basis, indicating, whether the corresponding pixel is correctly segmented (True) or whether an error occurs (False).

Thereafter, the system 200 for training a mask estimation model may calculate a binary classification loss (binary cross-entropy or 2-class cross-entropy) based on a difference between a predicted self-error map and a ground-truth self-error map to obtain a self-error loss.

Also, by comparing the training bounding box and the ground-truth bounding box, a bounding box loss may be calculated, and, by comparing the training instance mask and the ground-truth mask, a mask loss may be calculated, and, finally, these losses may be combined to train the model.

In this case, the system 200 for training a mask estimation model may calculate each of a self-error loss, a bounding box loss, and a mask loss in a form such as an L1 loss or a cross-entropy loss, and, through this, the system 200 for training a mask estimation model may calculate a loss function for a mask estimation model by summing the previously calculated self-error loss, the bounding box loss, and the mask loss.

In one embodiment, the system 200 for training a mask estimation model may calculate a loss function for a mask estimation model according to Equation 7 below.

$${L}_{SEED}^{t} = {λ}_{im} {L}_{im} ( {m}_{t} , \overline{m} ) + {λ}_{err} {L}_{e r r} ( {e}_{t} , \overline{e} ) + {λ}_{br} {L}_{b r} ( {b}_{t} , \overline{b} ) \qquad [ Equation 7 ]$$

Here, L^{t}_{SEED} denotes a loss function for a mask estimation model, λᵢₘ denotes a weight for a mask loss, Lim denotes a mask loss, λₑᵣᵣ denotes a weight for a self-error loss, λₑᵣᵣ denotes a self-error loss, λ_{br} denotes a weight for a bounding box loss, and L_{br} may denote a bounding box loss.

In another embodiment, the system 200 for training a mask estimation model may adjust a loss calculated in Equation 7 according to Equation 8 below.

$$L = {λ}_{cls} {L}_{cls} + {λ}_{ib} {L}_{ib} + {\sum }_{t = 1}^{k} {L}_{SEED}^{t} + {λ}_{mr} {L}_{mr} \qquad [ Equation 8 ]$$

Here, L denotes a finally calculated loss function, and L_{cls}, L_{ib}, and Lₘᵣ may respectively denote a loss for classification, an initial bounding box, and an instance mask correction by Mask R-CNN.

According to the configurations as described above, the instance segmentation system 100 and the system 200 for training a mask estimation model according to the present invention, through a single model, estimate an instance mask for a specific object from a target image and, by correcting self-error, may more accurately estimate an instance mask for an arbitrary object from an image.

In addition, the instance segmentation system 100 and the system 200 for training a mask estimation model according to the present invention, by repeating a process of correcting self-error for a bounding box and an instance mask estimated from a target image, may perform improvement for an instance mask estimated from an image more efficiently. The iterative self-error-based correction structure of the present invention, unlike a simple two-stage separated estimation based on existing Mask R-CNN, by directly predicting an error of an instance mask inside a model and reusing it by an iterative structure in the same model, has a technical effect of structurally reducing an error near an object boundary. This is a neural network internal structural improvement distinguished from a simple post-processing method such as threshold adjustment or a morphological operation, and provides a practical performance improvement that high accuracy may be maintained even for objects having high boundary complexity (for example, thin structures·overlapped objects). It may be implemented to be performed stepwise.

Further, the present invention described above may be implemented as a program executed by one or more processes in an electronic device and stored on a computer-readable recording medium.

Therefore, the present invention may be implemented as computer-readable code or instructions on a medium in which the program is recorded. That is, the various control methods according to the present invention may be provided in the form of a program, either in an integrated or individual manner.

Meanwhile, the computer-readable medium includes all kinds of recording devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, optical data storage devices, and the like.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the above detailed description is interpreted as being illustrative in every sense, not restrictive. The scope of the present invention should be determined based on the reasonable interpretation of the appended claims, and all of the alternations within the equivalent scope of the present invention belong to the scope of the present invention.

In addition to a basic embodiment, the present invention may be expanded in various forms. For example, an instance mask head may be replaced with a deconvolution-based upsampling network or a decoder based on a Transformer structure, and a self-error prediction head may also be configured as an attention-based weight adjustment module.

Also, an error-based correction method of the present invention may be applied to various forms of segmentation methods such as polygon segmentation, point-based segmentation, and instance-aware semantic segmentation in addition to a bounding box method. This means that the present invention is not limited to a specific model structure and has scalability that may be combined with various segmentation model architectures.

As a result, the present invention improves the internal functioning of an instance segmentation system by altering how object boundary errors are detected, represented, and corrected within a single computational pipeline, rather than merely improving an output accuracy of an image analysis algorithm.

What is claimed is:

1. An instance segmentation method, comprising:
receiving a target image;
estimating an initial bounding box corresponding to a specific object from the target image and estimating, based on the initial bounding box, an initial instance mask for the specific object;
predicting a self-error for the initial instance mask based on the initial bounding box; and
estimating, from the target image, a bounding box corrected according to the self-error, in consideration of the self-error for the initial bounding box and estimating an instance mask, based on the corrected bounding box and the self-error.

2. The instance segmentation method of claim 1, wherein the estimating of the initial instance mask comprises:
estimating, by using a pre-trained mask estimation model, a region corresponding to the specific object from the target image to generate the initial bounding box; and
estimating pixels corresponding to the specific object from the initial bounding box to generate the initial instance mask.

3. The instance segmentation method of claim 2, wherein the predicting of the self-error comprises:
combining, through the mask estimation model, in the target image, a region of interest according to the initial bounding box and the initial instance mask, and predicting the self-error from combined data.

4. The instance segmentation method of claim 3, wherein the estimating of the instance mask based on the self-error comprises:
combining, through the mask estimation model, the predicted self-error to the initial bounding box to estimate a bounding box in which the initial bounding box is corrected according to the self-error; and
combining the corrected bounding box corrected according to the self-error and the self-error, and estimating the instance mask corrected according to the self-error from combined data.

5. The instance segmentation method of claim 2, wherein the mask estimation model, as a single model, is implemented based on a configuration of Mask R-CNN.

6. The instance segmentation method of claim 1, wherein the self-error is predicted as a pixel-wise error map having a same spatial resolution as the initial instance mask.

7. The instance segmentation method of claim 6, wherein the self-error comprises a plurality of pixel-wise probability values indicating whether each pixel of the initial instance mask is correctly segmented or erroneously segmented.

8. The instance segmentation method of claim 7, wherein the self-error is represented as a multi-channel error map including at least a first channel corresponding to correctly segmented pixels and a second channel corresponding to erroneously segmented pixels.

9. The instance segmentation method of claim 1, wherein the estimating of the corrected bounding box comprises calculating correction parameters including at least one of a positional offset and a scale adjustment derived from the predicted self-error.

10. The instance segmentation method of claim 9, wherein the corrected bounding box is estimated by applying the correction parameters to the initial bounding box using a predefined mathematical transformation.

11. The instance segmentation method of claim 1, wherein the estimating of the corrected bounding box and the estimating of the instance mask are repeatedly performed a plurality of times based on the self-error.

12. The instance segmentation method of claim 11, wherein the repeated estimating is terminated when a change in the self-error between successive iterations is less than a predetermined threshold.

13. The instance segmentation method of claim 2, wherein the mask estimation model further includes a self-error prediction head configured to predict the self-error jointly with bounding box estimation and instance mask estimation.

14. The instance segmentation method of claim 13, wherein the self-error prediction head is configured to receive, as input, a combination of region-of-interest features corresponding to the initial bounding box and features derived from the initial instance mask.

15. The instance segmentation method of claim 4, wherein the corrected instance mask is estimated by combining the corrected bounding box and the self-error as input features to the mask estimation model.

16. The instance segmentation method of claim 1, wherein the mask estimation model is trained to minimize a loss function including at least one of a mask loss, a bounding box loss, and a self-error loss.

17. The instance segmentation method of claim 16, wherein the self-error loss is calculated based on a comparison between a predicted self-error and a ground-truth self-error derived from a ground-truth instance mask.

18. The instance segmentation method of claim 5, wherein the mask estimation model is implemented as a single unified network in which a bounding box head, a mask head, and a self-error prediction head share at least a portion of feature extraction layers.

19. An instance segmentation system, comprising:
a storage unit in which a target image is stored; and
a control unit configured to estimate an instance mask from the target image, wherein the control unit:
estimates an initial bounding box corresponding to a specific object from the target image;
estimates, based on the initial bounding box, an initial instance mask for the specific object;
predicts a self-error for the initial instance mask based on the initial bounding box;
estimates, from the target image, a bounding box corrected according to the self-error, in consideration of the self-error for the initial bounding box; and
estimates an instance mask, based on the corrected bounding box and the self-error.

20. A method for training a mask estimation model, comprising:
receiving training images and ground-truth masks which are labeling data for the training images;
inputting the training images to a mask estimation model to estimate a training initial instance mask for the training images;
predicting a self-error for the training initial instance mask through the mask estimation model, and estimating, based on the self-error, a training instance mask corrected from the training initial instance mask; and
comparing the training instance mask and the ground-truth masks, and training, based on a comparison result, the mask estimation model.
